(19) United States
(12) Patent Application Publication
(10) Pub. No.: US 2015/0135051 A1
(43) Pub. Date: May 14, 2015

(54) METHOD FOR AUTOMATICALLY GENERATING DOCUMENTS AND CORRESPONDING GENERATOR

(71) Applicant: Valipat S.A., Brussels (BE)

(72) Inventor: Olivier Gerardin, Uccle (BE)

(21) Appl. No.: 14/398,103

(22) PCT Filed: Apr. 22, 2013
(86) PCT No.: PCT/EP2013/058323

§ 371 Date: Oct. 30, 2014

(30) Foreign Application Priority Data
May 6, 2012 (EP) 12003549.8

(51) Int. Cl. G06F 17/24; G06Q 50/18; G06F 17/21

(52) U.S. Cl. CPC G06F 17/248; G06F 17/212; G06Q 50/18
USPC 715/223; 715/229

(57) ABSTRACT

The present disclosure relates to a method for automatically generating documents having parameterized content, and a corresponding generator. It can be applied, in particular, to the automatic generation of proxies or powers intended to authorize a proxy to perform an action on behalf of a principal. Document contains a plurality of paragraphs displayed according to a given layout, the content and the layout of at least one of the paragraphs being based on at least one parameter. A value of the first parameter is selected from a first list of values organized hierarchically in a database. A request to the database, also comprising different types of layout and the various pieces of content possible for the paragraphs, is executed via a generation module in order to obtain the layout and, for each paragraph, the content, associated with the selected value of the first parameter. The request returns the layout associated with a value of the first parameter of a hierarchical level higher than the selected value of said first parameter when the layout associated with this selected value is not present in the database.

### CROSS-REFERENCE TO RELATED APPLICATION(S)

This is a national phase application under 35 U.S.C. §371 of PCT Application No. PCT/EP2013/058323, filed Apr. 4, 2013, which claims the benefit of European application No. 12003549.8 filed May 6, 2012, the contents of which are expressly incorporated herein by reference.

### FIELD OF ART

The subject matter of the disclosure is a method for automatically generating documents with a parameterised content, and a corresponding generator.

### BACKGROUND

The present devices, systems, and methods find in particular an application in the automatic generation of documents such as proxies or powers of attorney that are intended to authorize an agent to perform an action on behalf of a principal. The document contains a plurality of paragraphs formatted in accordance with a certain layout, the content of at least one of said paragraphs and the layout, in particular the position of the paragraph, depending on at least one first parameter.

In many situations, a person, natural or legal, cannot perform a certain action himself, for practical reasons (distance, lack of time) and/or legal reasons (no authorisation to perform this action himself). This person must therefore have this action performed by another person, natural or legal, on his behalf.

By way of example, the power that permits a lawyer or a law firm to represent a person before a national or regional jurisdiction in order to perform legal and/or administrative actions can be cited.

The management of such powers of attorney may be administratively difficult and complicated. This is the case in particular in the usual situation in which the person who wishes to perform an action before several jurisdictions contacts his usual lawyer who is not himself authorised to perform said action in all the jurisdictions concerned. In such a case, the lawyer relies on a network of authorised lawyers to represent his client before the various jurisdictions concerned, and must take on the task of having his client sign a different power for each jurisdiction in which the action must be performed. This problem is posed in particular for performing actions (filing, withdrawal, etc.) relating to patent, trade mark or design and model applications.

In such a case, the lawyer must contact the authorised persons one by one, receive one by one the power forms that he must send for signature to his client (who is giving the authority), and then return them to the various lawyers in his network for performance of the action with the various jurisdictions.

To simplify this management, systems and methods are known that are based on the collection of powers that are scanned and stored in a database, or the concept of document-generation templates.

However, such systems and methods pose problems of maintenance, efficacy of storage and recovery of the information, and use.

In particular, with such systems or methods, amending the document requires renumbering the document or developing a new template, even if the amendment is minor.

Equally, when an amendment applies to a group of documents, it requires changes in each document and in each template.

### SUMMARY

The present devices, systems, and methods thus relates, according to a first aspect, to a method for automatically generating a document, such as a document of the proxy type intended to authorize an agent to perform an action on behalf of a principal, for example a power authorizing a lawyer or a patent agent to represent a client before a national or regional industrial property office for managing one or more industrial property rights.

The document contains a plurality of paragraphs, at least one of which is displayed according to a certain layout depending on at least one first parameter.

This parameter determines a context for generating the document.

The content and the layout, in particular the position of at least one of the paragraphs, therefore depend on this first parameter.

The method comprises a first step of selecting a value of the first parameter from a first list of values organised hierarchically in a database.

The database also comprises various types of layout and various contents possible for all or some of the paragraphs.

The layout and, for each paragraph, the content of this paragraph, associated with the selected value of the first parameter, are obtained by means of a request in the database.

When the layout associated with the selected value of the first parameter is not present in the database, the request returns a layout associated with a value of the first parameter with a hierarchical level higher than the selected value of this first parameter.

Alternatively or cumulatively, for each paragraph, when the content of this paragraph associated with the selected value of this first parameter is not present in the database, the request returns the content associated with a value of the first parameter with a hierarchical level higher than the selected value of this first parameter.

The method also comprises a step of generating the document in an electronic format, this document containing the contents of the paragraphs returned by the request and displayed according to the layout returned by the request.

By virtue of the present devices, systems, and methods, the hierarchical organization of the values of the first parameter, and its use by the method should no layout and/or no content be associated with a value, make it possible to mutualize certain paragraph contents that are repeated from one document to another.

This mutualisation makes it possible to reduce the quantity of information to be stored but also facilitates maintenance. It facilitates for example the creation of new documents to be generated, the content of which is close to other documents existing in the database. It also facilitates the application of the same amendment to a series of documents existing in the database.

This hierarchical organization and its use by the method of the present devices, systems, and methods also make it possible to always generate a document of a generic nature, that is to say the content and/or layout of which are associated with a value of the first parameter as high as possible in the hierarchical organization of these values, this highest possible level corresponding to the value closest to that selected (which may be this value in question) for which a content and/or a layout is present in the base.

In particular, if at the selected value of the parameter no content and/or layout is attributed, the method goes up by one hierarchical level in the possible values of the parameter and:
either attributes to the paragraph the content and/or layout of the parameter value of a higher level if such a content and/or layout is present in the base for this higher-level value,
or goes up again by one hierarchical level in the possible values of the parameter, and so on until it finds a content and/or layout relating to a parameter value.

The expression “is not present in the database”, where it is a question of information (layout, content or other) associated with a value of a parameter, means the fact that, for said value of the parameter, the database does not contain any value of the associated information, which may for example be represented by an empty field in the database.

Layout means the way in which the content of a paragraph is displayed in the document. The layout may therefore comprise characteristics relating to position, display font, display font size, display colour, underlining, framing, etc.

In a variant embodiment, the content of at least one paragraph is variable. Thus it may be personalisable.

Thus, for example, the document to be generated may comprise at least one paragraph the content of which is not, or is only partially, stored in the database, and depends on one or more variables the value of which may for example be directly entered by the user (the value then being editable) or obtained by request in another database.

The step of generating the document then comprises a step of entering in an entry form, or a step of recovering from another database, values of this or these variables, and a step of inserting this or these values in the content of the paragraph.

Thus the step of generating the document fills in, or completes, the paragraph with the value or values of the variable or variables, entered or recovered from another database and stored in the variables.

According to another particular embodiment in this case, the method comprises a step of generating an entry form that depends on the value of at least one parameter.

Thus the form itself depends on the value of one or more parameters and in particular the document generation context. This offers great flexibility to the method, which makes it possible, according to the context, to propose or not to the user a form dependent on this context.

In a variant, the step of selecting at least one parameter is done automatically according to the value of at least one other parameter and/or a value entered by the user. For example, in the context of the generation of powers of attorney relating to patents, the entry of the patent number makes it possible to recover its language from a public database, which may constitute the value of a parameter.

In another variant embodiment, optionally in combination with the previous ones, the content and the layout, in particular the position, of at least one of the paragraphs depend on a plurality of parameters, each parameter being able to adopt a value from a list of values, all or some of these list of values being organised hierarchically.

This plurality of parameters determines a context for generating the document.

The selection step then comprises steps of selecting the respective values of these parameters from a plurality of lists of respective values.

Should all the values of several parameters be organized hierarchically, the method may provide the order in which the parameters must be taken into account and their values analyzed in their hierarchy in accordance with the present devices, systems, and methods. The method may also provide the way in which the values are requested with respect to one another in this context; in particular, it is a case for example of the question whether, the values of a first parameter having been analyzed one after the other in their hierarchy in order find a content and/or a layout, account must where applicable be taken, in analyzing the values of the second parameter, of the value of the first parameter as selected initially or the value of the first parameter with a value hierarchically higher for which a content and/or a layout was present in the base.

In a variant embodiment, the content and layout of at least one of the paragraphs being dependent on the first and at least a second parameter, the second parameter is dependent on the first parameter.

Thus the list of values proposed for the second parameter, or the very fact of proposing a list of values for the second parameter, is dependent on the value of the first parameter.

In particular in this case, the selection step then comprising the selection of a value of the second parameter from a second list of values stored in the database, optionally organised hierarchically, which depends on the selected value of the first parameter.

It should be noted here that, should a paragraph have a variable content, the personalisation of this content, whether by the generation of a form to be filled in or the recovery of information in a database, may depend on the generation context and in particular the values entered for the various parameters.

The present devices, systems, and methods also relate, according to a second aspect, to a system for automatically generating a document, such as a document of the power type intended to authorize an agent to perform an action on behalf of a principal.

The document contains a plurality of paragraphs, at least one of which is displayed according to a certain layout, the content and the layout of at least one of these paragraphs being dependent on at least one first parameter.

The possible values of the first parameter are organised hierarchically in a first list of values stored in a database.

The various possible contents of the paragraphs, and the various types of layout, associated with the values of the first parameter, are also stored in the database.

The system comprises a generation module able to make a request in the database in order to obtain, from a determined value of the first parameter, the content of the paragraph or paragraphs and the layout of this or these paragraphs, associated with the determined value of the first parameter.

The generation module is arranged so that, if the layout associated with the determined value of the first parameter is not present in the database, the request returns the layout associated with the value of the first parameter with a hierarchical level higher than the determined value of this first parameter.

In combination with the previous feature, or alternatively thereto, if, for each paragraph, the content associated with the value of the first parameter is not present in the database, the request returns the content associated with a value of the first parameter with a hierarchical level higher than the value of this first parameter.

In addition, the generation module is also able to generate a document in an electronic format, containing the contents of the paragraphs returned by the request, displayed according to the layout returned by the request.

The system of the present devices, systems, and methods procures advantages similar to those procured by the method of the present devices, systems, and methods presented above.

More generally, the database is included in a knowledge base.

In a variant embodiment, the content of at least one paragraph is variable. It is thus personalisable.

Thus, for example, the content of at least one paragraph is not, or is only partially, stored in the database, but able to be entered directly by the user (the value then being editable) or obtained by request in another database.

The generation module is then able to recover the value or values of the variables in an entry form, or by request in another database, and to insert this or these values in the content of the paragraph.

Thus the step of generation of the document fills in, or completes, the paragraph with the content entered or recovered in the other database and stored in the variables.

According to a particular embodiment in this case, the system comprises means able to generate an entry form according to the value of at least one parameter.

The present devices, systems, and methods also relate, according to a third aspect, to a document, in particular of the power type intended to authorize an agent to perform an action on behalf of a principal, the document containing a plurality of paragraphs displayed according to a certain layout, the content and layout of at least one of the paragraphs depending on at least one first parameter, the document being obtained by the method as presented above.

Other features and advantages of the present devices, systems, and methods will emerge more clearly from a reading of the following description of the preferred variant embodiments and implementations, which are given by way of non-limitative examples with reference to the accompanying drawing.

### BRIEF DESCRIPTION OF THE FIGURE

FIG. 1: shows a schematic depiction of the main elements of an exemplary system according to the disclosure.

### DETAILED DESCRIPTION

The present devices, systems, and methods is illustrated below using an example of the generation of documents consisting of powers intended to enable a local representative to perform an action on behalf of an applicant with a local body or authority.

It may be a case for example, in the field of industrial property, of powers for filing a patent application or registering a trade mark with competent local bodies.

The powers (P) are organised in paragraphs (par,) disposed according to a certain layout (MP).

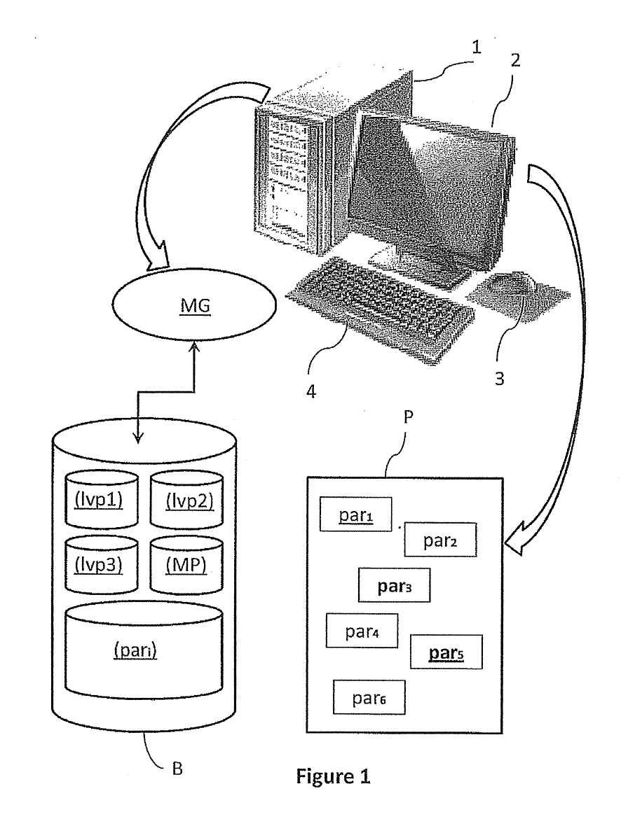

In the example depicted in FIG. 1, the document (P) contains six paragraph par₁ to par₆, positioned at given points, displayed with a certain display font, a certain size, underlined or not, in bold characters or not.

Layout means all the display features determining the position according to which and the way in which the contents of the paragraph are displayed. It may therefore be a case, apart from the position characteristics, of the display font characteristics, display font size, display colour, underlining, framing, etc.

This layout (MP) and the content of the paragraphs (parᵢ) depend on a certain number of parameters (pᵢ), in this case a first parameter (p₁) consisting of the nature of the action for which the power is given, a second parameter (p₂) consisting of the local body with whom the action is to be performed, a third parameter (p₃) consisting of the specific or general nature of the power (P) to be generated.

These parameters p₁, p₂, p₃ may take values grouped together in lists of values Ivp₁, Ivp₂, and Ivp₃ stored in a database (B).

In the example in FIG. 1, the database (B) therefore comprises the various possible values (filing, withdrawal, etc) for the nature of the action (p₁). The nature or type of the action thus constitutes a first parameter that participates in the determination of the content and layout of the paragraphs of the document (P).

Likewise, the database (B) comprises, in this example, the various possible values (European Patent Office (EPO), United States Patent and Trademark Office, etc.) for the local body (p₂) with whom the action (p₁) must be performed. This local body thus constitutes a second parameter that participates in the determination of the content and layout of the paragraphs of the document (P).

In this example, the various possible values for the second parameter (p₂) may depend on the possible values for the nature of the action (p₁).

Thus the value vp₂=“EPO” is a possible value of the second parameter p₂ when the value of the first parameter p₁ is vp₁=“filing of a patent application”, but is not a possible value of this second parameter p₂ when the value of the first parameter p₁ is vp₁=“registration of a trade mark”.

The list of possible values (Ivp₁) for the first parameter p₁, that is to say the nature of the action, is organised hierarchically.

Thus, by way of example, the first parameter p₁ may take the following values vp₁: “any action—intellectual property”, with a higher level than “any action—patent”, with a higher level than “filing of a patent application” and “payment of an annual patent fee”.

The list of possible values (Ivp₂) for the second parameter p₂, that is to say the local body in our example, may also be organised hierarchically. In this case, this is not so.

Thus a layout of the various paragraphs in the document (P) corresponds to a pair of values (vp₁·vp₂), for example (“filing of a patent application”, “Belgium”).

Such a pair of values generally correspond to contents for the various paragraphs (parᵢ) constituting the document (P) to be generated, which are also stored in the database (B).

The system and method of the present devices, systems, and methods thus enable a user to select a value vp₁ for the first priority p₁ among the list of possible values (Ivp₁) stored in the database (B), during a selection step (S).

This selection may for example be done by means of an interface represented by a computer screen on which the various possible values vp₁ are presented.

When the selection of a value vp₁ for the first paragraph p₁ is made, for example “filing of a patent application”, and then the selection of a value vp₂ for the second parameter p₂ is made, for example “Belgium”, a generation module (MG) makes a request (R) in the database (B) in order to recover the layout (MP) and the contents of the paragraphs. (parᵢ) corresponding to this generation context.

For a given paragraph, if the content exists, it is returned by the request (R). However, if the content is not present in the database (B), that is to say for the selected value of the parameter p₁ the database does not include a value for the content (for example the field is empty in the database), the request (R) returns the content of the paragraph in question corresponding to a value of the parameter p₁ with a level higher than the selected value; if the content corresponding to the value of the parameter p₁ with a higher level is also not present in the base (B), the request (R) returns the content of the paragraph corresponding to the value of the parameter p₁ with an even higher level, and so on until a content is found for the paragraph.

Thus, if the selected value vp₁ for the parameter p₁ is “filing of a patent application”, for a value vp₂ of the second parameter p₂ equal to “Belgium”, and for this pair of values (vp₁, vp₂) the database (B) does not contain any content for the paragraph (parᵢ) in question, the request (R) made by the generation module (MG) returns the value corresponding to the pair (“any action—patent”, “Belgium”).

Likewise, if for this pair of values (vp₁, vp₂) the database (B) does not contain a specific layout for all the paragraphs (parᵢ) forming the document (P), the request (R) made by the generation module (MG) returns the layout corresponding to the pair (“any action—patent”, “Belgium”).

This organisation of the data makes it possible in particular to mutualise certain paragraph contents and/or layouts that are repeated from one document to another. This may be the case for example with the title of the document (P), which may possibly be the same (“Power of Attorney”) whatever the nature of the action to be performed with a given body.

In the case where the power is in a bilingual English/local language form, this may also be the case with some paragraphs in English that remain the same whatever the nature of the action and/or the body with whom the action is to be performed.

This mutualisation makes it possible in particular thus to reduce the quantity of information to be stored. It also facilitates maintenance. This is the case for example when it is a question of the creation of new documents to be generated, the content of which is close to other documents existing in the database (B). This may also be the case when it is a question of the same amendment to be applied to a series of documents existing in the database (B).

The generation module (MG) next generates the document (P), in an electronic format, by placing the various contents of paragraphs (parᵢ) obtained in the database (B) from the determined value or values of the parameter or parameters. (pᵢ) according to a layout (MP) that itself depends on the parameter or parameters (pᵢ).

It is possible to provide for some of the paragraphs (parᵢ) to have a content that is only partially (or not at all) managed and therefore stored in the database (B), and depicted in the form of variables (vᵢ).

In the example of a power for depositing a patent application, it may be a case for example of the paragraph corresponding to the name of the applicant represented by the variable vᵢ=name_applicant, or a name of the agent represented by the variable v₂=name_agent. These data may then be obtained by means of an entry form generated by the system on the screen of a computer, and/or by a request in another database such as a database of agents.

They are then replaced by the corresponding paragraphs (par,) for generating the document (P). They appear in the content of the corresponding paragraphs (parᵢ) in the database in the form of their variable name (vᵢ).

The generation module MG is implemented for example on the central unit 1 of a computer system 1, 2, 3, 4, which may also comprise conventionally a display device 2 such as a screen, a pointing device 3 and an input device 4 such as a keyboard.

The database B may be stored in the central unit 1 of the computer system 1, 2, 3, 4 on which the generation module MG is executed, or be stored in a separate and/or remote storage device accessible by any ad hoc communication means.

This database B may itself be stored on a single storage device, or distributed over several storage devices distant from one another.

Furthermore, the generation module MG may be implemented on a single central unit 1 as depicted in FIG. 1, or be implemented in a distributed fashion over several units distant from one another, according to distributed architectures known to persons skilled in the art.

The document P generated by the generation module MG may thus be displayed on the display device 2, stored in the central unit 1, printed, etc.

However, usually, the display and recovery of the document P generated will be done on a machine distant from the central unit 1, this distant machine communicating with the central unit 1 by means of a communication network such as the internet. More precisely, in this case, the system of the present devices, systems, and methods can be implemented in a distant computer system such as a web server accessible via a communication network such as the internet or an intranet to a user using this system via a web interface through which he selects the values of the various parameters, the web interface communicating with the computer system of the present devices, systems, and methods in a conventional manner. The documents generated can be downloaded from this web interface; they may also be displayed by the latter.

The whole of the above description is given by way of example and is not limitative of the present devices, systems, and methods.

In particular, the present devices, systems, and methods are not limited to the generation of powers, or even more so the generation of powers in the field of intellectual property.

It applies to the generation of any other type of document, provided that the content and layout of the document are parameterised by at least one parameter, the possible values of which are organised hierarchically.

Equally, the present devices, systems, and methods are not limited to a given computer architecture as depicted in FIG. 1. Both the database B and the generation module MG can be implemented in a distributed fashion or not, on the same unit or not. Furthermore, the generation of the document P may just as well take place in the unit 1 on which the generation module MG is implemented or at a distant unit connected to the central unit by means of a communication network, or both.

Moreover, information other than the content of the paragraphs and the layout thereof could be determined by the parameter or parameters. The existence or not of a power, the paper used for printing thereof, etc., may for example be thought of.

1. A method for automatically generating a document, in particular of the proxy type intended to authorize an agent to perform an action on behalf of a principal, the document containing a plurality of paragraphs at least one of which is displayed according to a certain layout, the content and the layout of at least one of said paragraphs depending on at least one first parameter,
comprising:
selecting a value of the first parameter from a first list of values organised hierarchically in a database,
making a request, in the database also comprising various types of layout and various possible contents for all or some of the paragraphs, in order to obtain the layout and, for each paragraph, the content of said paragraph, associated with the selected value of the first parameter, said request returning the layout associated with a value of the first parameter of the hierarchical level higher than the selected value of this first parameter when the layout associated with said selected value is not present in the database, and/or returning, for each paragraph, the content associated with a value of the first parameter with a hierarchical level higher than the selected value of this first parameter when the content associated with said selected value is not present in the database,
generating said document in an electronic format, containing the contents of the paragraphs returned by said request and displayed according to the layout returned by said request.

2. The method according to claim 1, wherein the document comprises at least one paragraph the content of which is variable.

3. The method according to claim 2, wherein the content of the paragraph is not, or is only partially, stored in the database, and depends on one or more variables, characterized in that it comprises a step of entering in an entry form, or a step of recovering in another database, the value of the variable or variables, and in that the step of generating the document inserts this or these values in the content of the paragraph.

4. The method according to claim 3, further comprising a generating an entry form that depends on the value of at least one parameter.

5. The method of claim 1, wherein selecting at least one parameter is performed automatically according to the value of at least one other parameter and/or a value entered by the user.

6. The method of claim 1, wherein the content and the layout of at least one of the paragraphs depending on a plurality of parameters, each parameter being able to take a value from a list of values, all or some of these lists of values being organised hierarchically, the selection step comprises steps of selecting the respective values of said parameters.

7. The a method of claim 6, wherein the content and the layout of at least one of the paragraphs depending on the first and at least one second parameter, the second parameter is dependent on the first.

8. The method of claim 7, wherein the selection step comprises the selection of a value of the second parameter from a second list of values stored in the database, optionally organized hierarchically, depending on the selected value of the first parameter.

9. A system for automatically generating a document, in particular of the proxy type intended to authorize an agent to perform an action on behalf of a principal, the document containing a plurality of paragraphs at least one of which is displayed according to a certain layout, the content and layout of at least one of said paragraphs being dependent on at least one first parameter, the possible values of the first parameter being organized hierarchically in a first list of values stored in a database, the various types of layout and the various possible contents of all or some of the paragraphs associated with the possible values of the first parameter being stored in said database,
comprising a generation module able to:
make a request in the database in order to obtain the layout and, for each paragraph, the content, associated with a determined value of the first parameter, said request making it possible to obtain:
the layout associated with a value of the first parameter with a hierarchical level higher than the determined value of this first parameter when the layout associated with said determined value is not present in the database, and/or
for each paragraph, the content associated with a value of the first parameter with hierarchical level higher than the determined value of this first parameter when the content associated with said determined value is not present in the database,
generating a document in an electronic format, containing the contents of the paragraphs returned by the request displayed according to the layout returned by the request.

10. The system according to claim 9, wherein the content of at least one paragraph not being, or being only partially, stored in the database and dependent on one or more variables, characterised in that the generation module is able to recover the value of the variable or variables in an entry form or in another database and to insert this or these values in the content of the paragraph.

11. The system according to claim 10, further comprising means able to generate an entry form according to the value of at least one parameter.

12. A document, in particular of the proxy type, intended to authorise an agent to perform an action on behalf of a principal, the document containing a plurality of paragraphs at least one of which is displayed according to a certain layout, the content and the layout of at least one of said paragraphs being dependent on at least one first parameter, obtained by the method according to claim 1.
